(19) United States
(12) Patent Application Publication
(10) Pub. No.: US 2016/0025354 A1
(43) Pub. Date: Jan. 28, 2016

(54) FILTER UNITS, FILTRATION SYSTEMS, AND METHODS OF USING

(71) Applicant: Blissfield Manufacturing Company, Blissfield, MI (US)

(72) Inventors: Daniel W. Sikkenga, Adrian, MI (US); Christopher L. Schultz, Onsted, MI (US); Thomas A. Parott, Blissfield, MI (US); Antonio R. Galvan, Adrian, MI (US); Brian A. Ford, Blissfield, MI (US); Patrick D. Farver, Adrian, MI (US); Dean Osenbaugh, Sylvania, OH (US); Darcy McMenamin, Holbrook, MA (US)

(21) Appl. No.: 14/625,061

(22) Filed: Feb. 18, 2015

Related U.S. Application Data
(63) Continuation-in-part of application No. 14/338,665, filed on Jul. 23, 2014.

(51) Int. Cl. F24C 15/20; B01D 45/08

(52) U.S. Cl. CPC F24C 15/2035; B01D 45/08

(57) ABSTRACT

Filter units and filtration systems, as well as methods of using such units and systems to remove particulates from air, for example, within a kitchen environment. Such a filter unit includes a heat exchanger within a housing, an access opening at a lateral end of the filter unit that defines a lateral narrowed section of the filter unit. The access opening provides access to headers of the heat exchanger through openings in enclosures that partially enclose ends of the headers. If one or more filter units are combined end-to-end to form a filtration system, a closure can be provided to removably close a through-passage formed by the access openings of two adjacent units.

### CROSS REFERENCE TO RELATED APPLICATIONS

This is a continuation-in-part patent application of co-pending U.S. patent application Ser. No. 14/338,665, filed Jul. 23, 2014, whose entire contents are incorporated herein by reference.

### BACKGROUND OF THE INVENTION

The present invention generally relates to filters of the type used in cooking environments to remove grease, oil and other particulates from the air. More particular, the invention relates to a filter unit and method for filtering particulates from hot fumes and transferring heat from the hot fumes to a fluid circulating within the unit. The heated fluid may then be used to supply heat for purposes such as heating water, air, etc.

During the operation of commercial or institutional kitchens, a significant amount of heat energy is often lost as a result of hot fumes and/or air being vented to the atmosphere. These hot fumes may be generated from cook stoves, hot plates, deep fat fryers, and other cooking apparatus. As a result of heat and a variety of particulates generated during cooking, it is necessary for the comfort and health of kitchen workers to exhaust these fumes, usually on a continuous basis, through flue chimneys or similar venting devices. This process effectively replaces warm air within a kitchen with cooler, cleaner air from the outside environment (atmospheric air). Although air circulation is necessary to provide a constant source of clean air to a kitchen environment, simply venting the warm air within a kitchen to the environment is inefficient and uneconomical, especially in colder climates where the cost to heat air and water within a building can be significant.

A further problem that can be encountered in commercial kitchens is the filtering of grease, oil and other particulates entrained in the hot fumes generated during the cooking of foods. If improperly filtered, entrained grease, oil and particulates can cause fouling and the eventual malfunction of air ventilation systems, as well as create fire hazards if allowed to accumulate. Accordingly, hot fume air filter units, which are often located in fume hoods, ventilation units, exhaust units, or another type of filtration system over cooking surfaces, are generally required to be cleaned on a regular basis.

Filter units that incorporate a heat exchanger to capture thermal energy above cooking surfaces are known, notable examples of which include filter units disclosed in U.S. Pat. Nos. 8,728,189, 8,852,307, and 8,945,263. While such filter units provide certain notable advancements, further improvements are desirable.

### BRIEF DESCRIPTION OF THE INVENTION

The present invention provides filter units and filtration systems, as well as methods of using such units and systems to remove grease, oil and other particulates from air, for example, within a kitchen environment.

According to one aspect of the invention, a filter unit includes a heat exchanger having headers and a plurality of conduits between and fluidically connecting the headers to define fluid flow passages within the heat exchanger. The headers comprising at least first and second headers that each have oppositely-disposed first and second ends, and at least the first header has a port disposed at the first end thereof that is fluidically connected to the fluid flow passage within the first header. The filter unit further includes a housing having first and second walls and a cavity therebetween in which the heat exchanger is disposed. The first wall has at least a first entrance opening therein, and the second wall has at least a first exit opening therein. The first and second walls define a pair of partial enclosures that partially enclose the first ends of the first and second headers of the heat exchanger at a first lateral end of the filter unit. Each of the partial enclosures has an opening through which a corresponding one of the first ends of the first and second headers is exposed, and the partial enclosures face each other across an access opening at the first lateral end of the filter unit. The access opening defines a lateral narrowed section of the filter unit, provides access to the first ends of the first and second headers through the openings in the partial enclosures, and provides access to the port of the first header through the opening in a first of the partial enclosures.

According to another aspect of the invention, a filter unit includes a housing having an upstream wall disposed at an upstream side of the housing, a downstream wall disposed at a downstream side of the housing, and a cavity therebetween in which a heat exchanger is disposed. The heat exchanger has headers and a plurality of conduits between and fluidically connecting the headers to define fluid flow passages within the heat exchanger. The headers include at least first and second headers that each have oppositely-disposed first and second ends, with at least the first header having a port disposed at the first end thereof that is fluidically connected to the fluid flow passage within the first header. The upstream wall of the housing has a first entrance opening therein and first and second upstream wall portions separated by the first entrance opening, and the downstream wall of the housing has first and second exit openings therein and a downstream wall portion between the first and second exit openings. The upstream and downstream walls define first and second pairs of partial enclosures that partially enclose, respectively, the first and second ends of the first and second headers of the heat exchanger at oppositely-disposed first and second lateral ends of the filter unit. Each partial enclosure has an opening through which a corresponding one of the first and second ends of the first and second headers is exposed. The first pair of the partial enclosures face each other across a first access opening at the first lateral end of the filter unit, and the second pair of the partial enclosures face each other across a second access opening at the second lateral end of the filter unit. The first and second access openings define therebetween a narrowed section of the filter unit, the first and second access openings provide access to, respectively, the first and second ends of the headers through the openings in the first and second pairs of partial enclosures, and the first access opening provides access to the port of the first header through the opening in a first of the partial enclosures of the first pair of partial enclosures.

According to another aspect of the invention, a filtration system includes first and second filter units arranged so that a lateral end of the first filter unit is adjacent a lateral end of the second filter unit. Each of the first and second filter units has a heat exchanger within a housing that defines a flow path through the heat exchanger. The first and second filter units have narrowed sections that define therebetween a through-passage through the filtration system that bypasses the flow paths of the first and second filter units. The first filter unit has a drain port and the second filter unit has a supply port that are fluidically connected to each other and are disposed within the through-passage. The filtration system further includes a removable closure that removably closes the through-passage and provides access to the drain port of the first filter unit and the supply port of the second filter unit within the through-passage.

Other aspects of the invention include methods of using one or more filter units or a filtration system as described above to collect particulates.

Other aspects and advantages of this invention will be better appreciated from the following detailed description.

### BRIEF DESCRIPTION OF THE DRAWINGS

FIG. 1 is a perspective view of a filter unit in accordance with a nonlimiting embodiment of this invention.

FIGS. 2 and 3 represent, respectively, front and rear views of the filter unit of FIG. 1.

FIG. 4 represents a cross-sectional view of the filter unit taken along section line 4-4 of FIG. 2.

FIG. 5 represents an exploded view of the filter unit of FIG. 1, and shows a housing comprising a front cover and rear base, and a heat exchanger enclosed within the housing.

FIGS. 6, 7 and 8 represent perspective, front, and side views of the heat exchanger of FIG. 5.

FIG. 9 represents a filtration system comprising multiple filter units of the type represented in FIGS. 1 through 5.

### DETAILED DESCRIPTION OF THE INVENTION

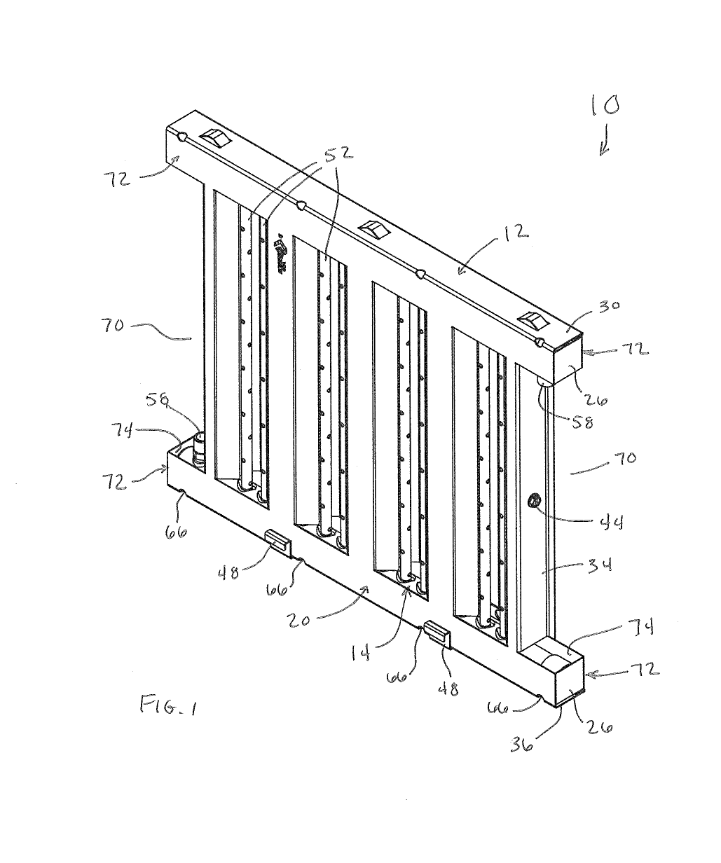

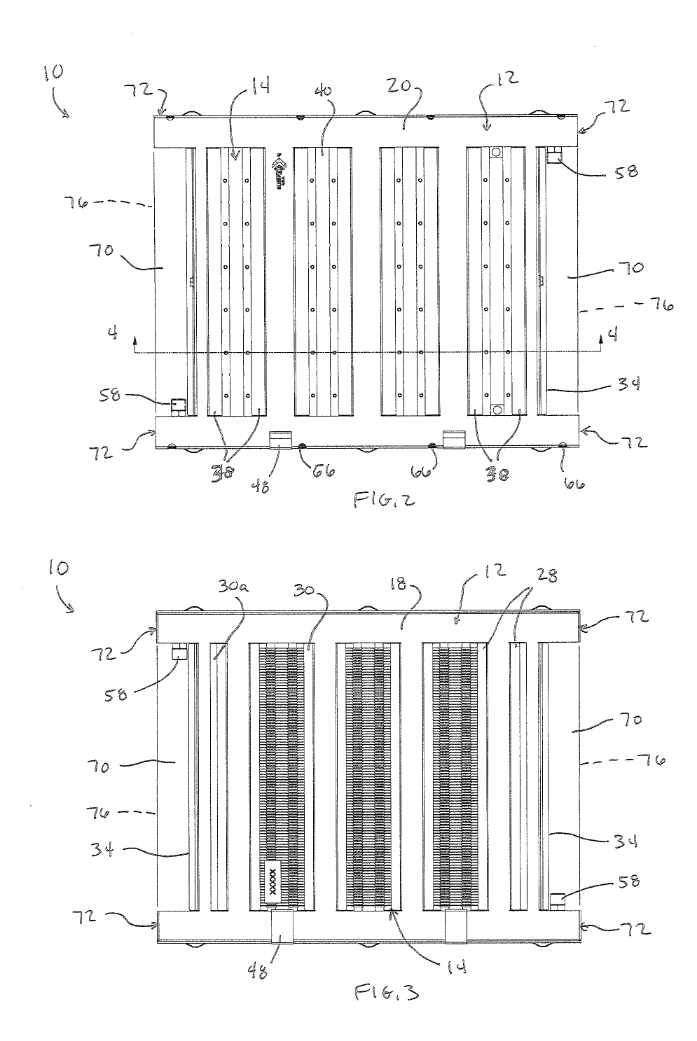

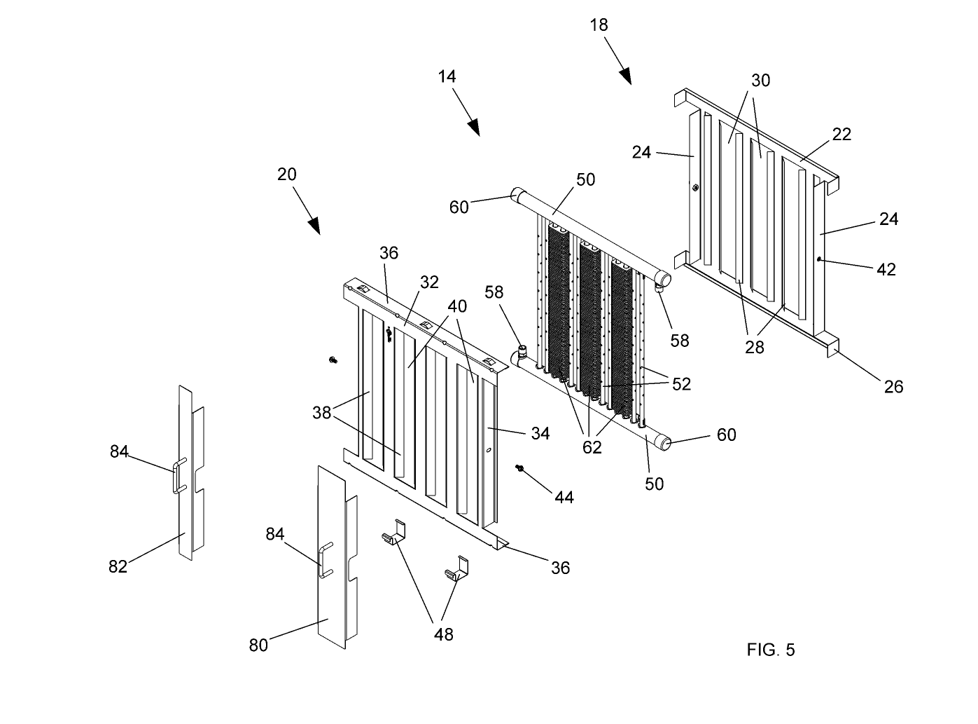

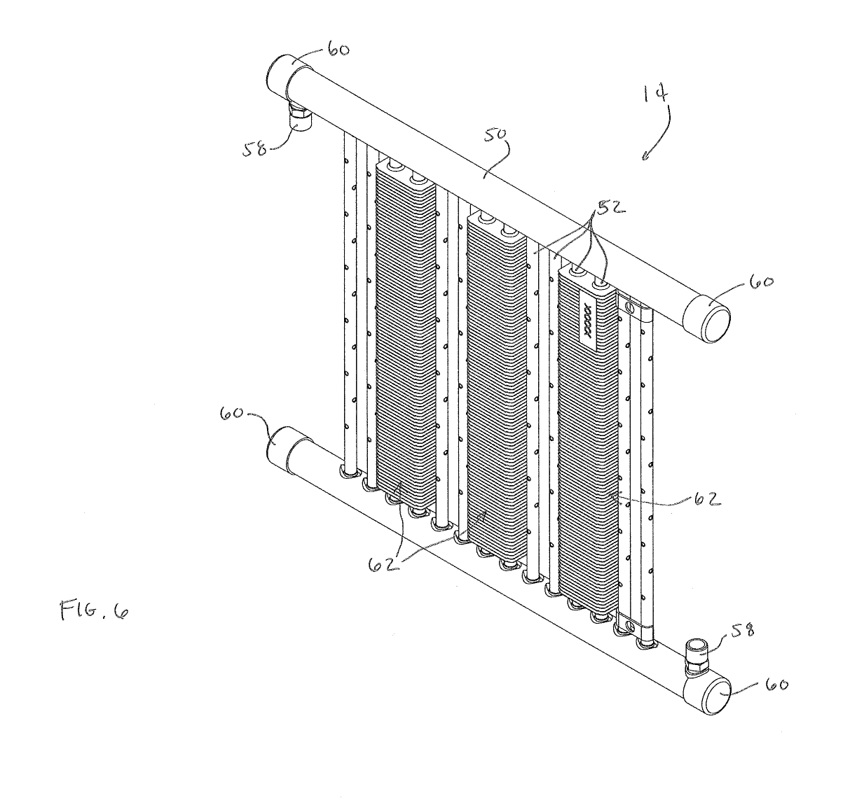

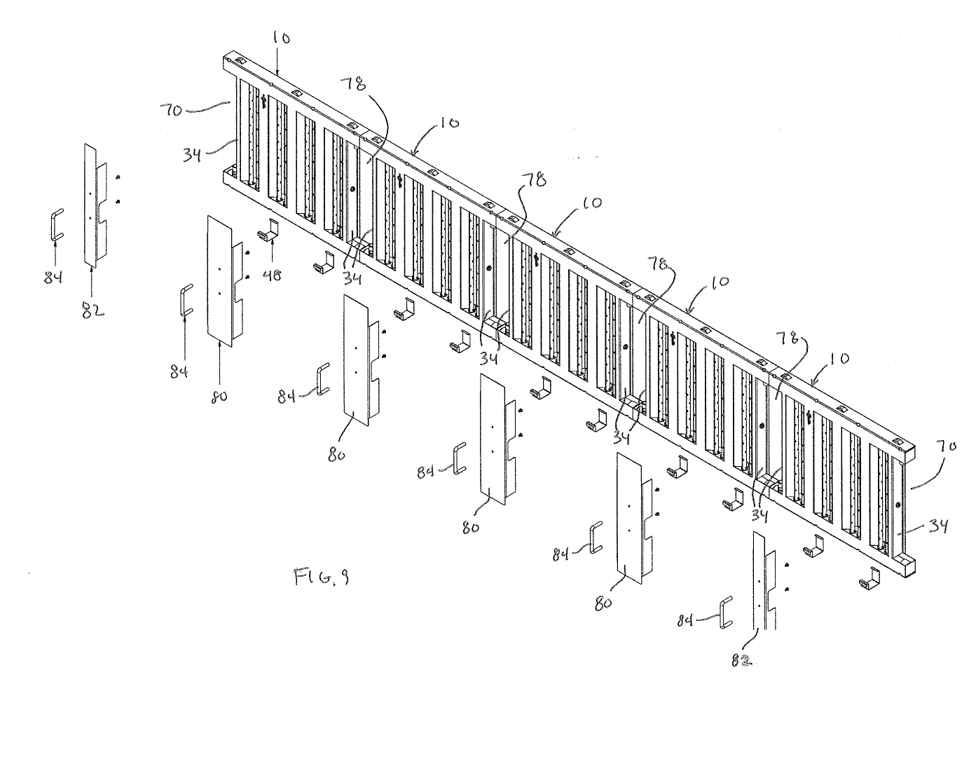

FIGS. 1 through 4 depict a filter unit (cartridge) 10 and FIGS. 5 through 8 depict components of the unit 10 in accordance with a nonlimiting embodiment of the present invention. FIGS. 2 and 3 represent front and rear views of the filter unit 10, which are terms used in reference to the direction that air travels through the unit 10, namely, entering the unit 10 through the front (entrance) side visible in FIG. 2 and exiting the unit 10 through the rear (exit) side visible in FIG. 3. The unit 10 will be described in reference to its installation in a fume hood, ventilation unit, exhaust unit, or the like in a kitchen for the purpose of removing particulates (e.g., grease, oil, and other contaminants) that might be entrained in hot fumes generated during the cooking of foods. However, other applications for the unit 10 are foreseeable and within the scope of the invention.

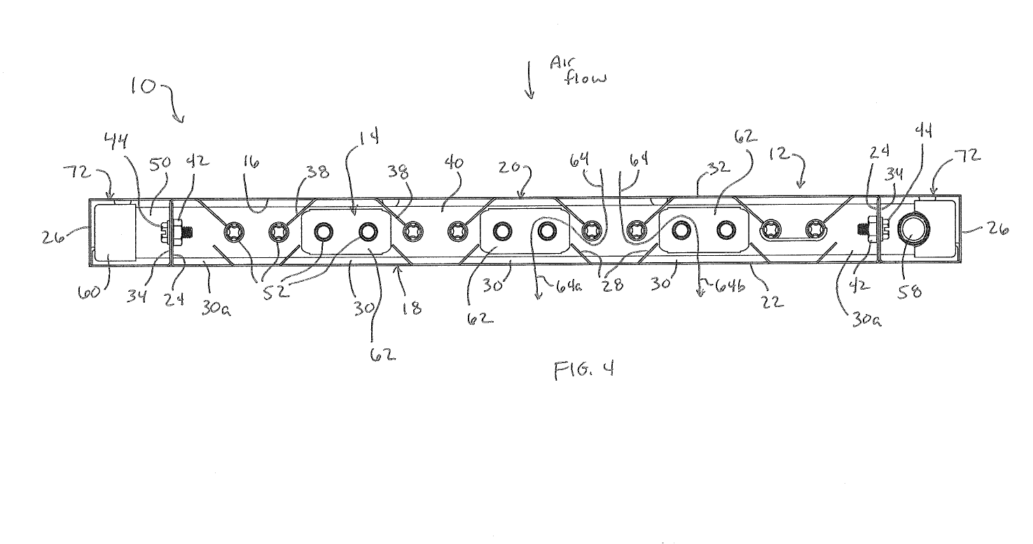

The filter unit 10 depicted in FIGS. 1 through 4 is rotationally symmetrical (of order 2) in the plane of the unit 10. The unit 10 is represented in FIGS. 1 through 5 as comprising a housing 12 and a heat exchanger 14 adapted to be substantially enclosed by the housing 12. The heat exchanger 14 is preferably sized so as to be positioned substantially within a cavity 16 (FIG. 4) within the housing 12, and can be seen in FIG. 5 to be rotationally symmetrical (of order 2) in the plane of the heat exchanger 14, such that it may be inserted into the cavity 16 in either of two orientations. The housing 12 preferably comprises a base 18 and cover 20, which are intended to be disposed at, respectively, the rear (exit) and front (entrance) sides of the filter unit 10. The base 18 and cover 20 are each roughly a parallelepiped with openings that face each other. The base 18 and cover 20 can be formed from a stainless steel, though other materials are foreseeable, for example, other steel alloys, aluminum alloys, copper alloys, and polymers. The base 18 and cover 20 can each be individually fabricated as a unitary member, though their construction as assemblies formed by welding, fastening, etc., is also foreseeable.

The base 18 is represented in FIG. 5 as rotationally symmetrical (of order 2) in the plane of the base 18 to allow the base 18 to be assembled with the cover 20 in either of two orientations. The base 18 is shown as comprising a base wall 22 and lateral side members 24 that extend from the base wall 22. As indicated in FIG. 5, each side member 24 has a length that allows its insertion between headers 50 of the heat exchanger 14. Furthermore, the base 18 is represented in FIG. 5 as comprising flanges 26 that partially surround and may contact the ends of the headers 50 to position the heat exchanger 14 during and after installation in the housing 12. The base 18 also comprises baffles 28 that may be integrally formed with or attached to the base wall 22. Each baffle 28 is disposed along an edge of an opening 30 defined in the base wall 22, and projects from the base wall 22 at an oblique angle to the base wall 22. As evident from FIG. 4, the openings 30 serve as exits of the filter unit 10, and as such will hereinafter be referred to as exit openings 30. Three main exit openings 30 and two smaller side exit openings 30a are represented as being provided in the embodiment of the base 18 shown FIGS. 1 through 5, though fewer or greater numbers of exit openings 30 are foreseeable. As evident from FIGS. 3, 4 and 5, wall portions of the base wall 22 are separated by each of the exit openings 30 and 30a.

The cover 20 is shown in FIG. 5 as rotationally symmetrical (of order 2) in the plane of the cover 20 to allow the cover 20 to be assembled with the base 18 in either of two orientations. Similar to the base 18, the cover 20 can also be seen in FIG. 5 to comprise a base wall 32 and lateral side members 34 that extend from the base wall 32. As represented in FIG. 5, the lengths of the side members 34 allow insertion of the side members 34 between headers 50 of the heat exchanger 14. As evident from FIGS. 1 and 4, the side members 34 of the cover 20 preferably overlap the side members 24 of the base 18 when the cover 20 and base 18 are assembled to form the housing 12. The cover 20 is also represented in FIG. 5 as comprising flanges 36 that partially surround and support the headers 50 along their longitudinal lengths. With the base wall 22 and flanges 26 of the base 18, the base wall 32 and flanges 36 of the cover 20 enclose the headers 50 of the heat exchanger 14, with the exception of portions of the ends of the headers 50 that face each other, as evident from FIG. 1. In particular, the base walls 22 and 32 and flanges 26 and 36 of the base 18 and cover 20 define partial enclosures 72, each having an opening 74 through which one of the ends of the headers 50 is exposed. The cover 20 also comprises baffles 38 that may be formed integrally with or attached to the base wall 32. Each baffle 38 is disposed along an edge of an opening 40 defined in the base wall 32 of the cover 20, and projects from the base wall 32 at an oblique angle to the base wall 32. As evident from FIG. 4, the openings 40 serve as entrances of the filter unit 10, and as such will hereinafter be referred to as entrance openings 40. Four entrance openings 40 are represented as being provided in the embodiment of the cover 20 shown FIGS. 1 through 5, though fewer or greater numbers of entrance openings 40 are foreseeable. As evident from FIGS. 1, 2, 4 and 5, wall portions of the base wall 32 are separated by each of the entrance openings 40.

The side members 24 and 34 of the base 18 and cover 20 have threaded openings and/or weld nuts 42 that, after assembling the base 18 and cover 20 so that the side members 34 of the cover 20 overlap the side members 24 of the base 18, allow for the use of fasteners 44 to secure the side members 34 to the side members 24. The weld nuts 42 and fasteners 44 allow for disassembly of the housing 12 for cleaning and repair of the filter unit 10.

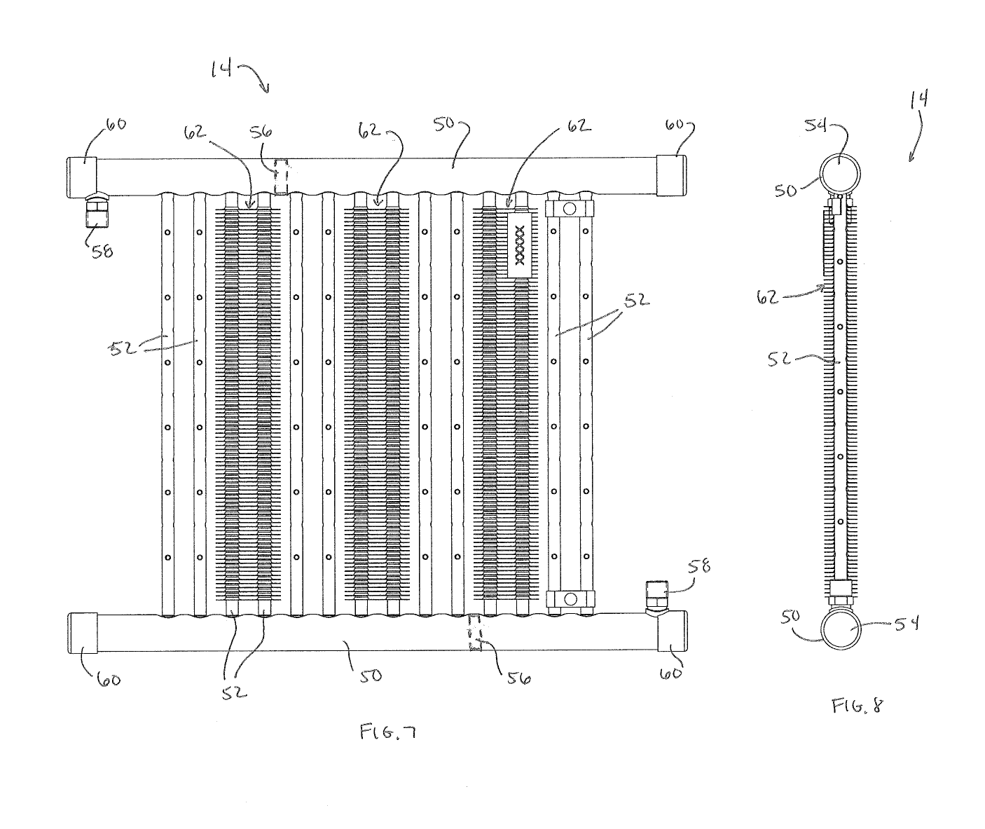

The heat exchanger 14 can be seen in FIGS. 5 through 8 as comprising the aforementioned headers 50 and a plurality of conduits (tubes) 52 between and fluidically connecting the headers 50 to define fluid flow passages 54 within the heat exchanger 14 through which a fluid, for example, a refrigerant such as water or propylene glycol, is able to flow. As represented in FIG. 7, though the conduits 52 have a parallel arrangement, dams 56 are preferably present within the headers 50 to create a serpentine flow path for a fluid flowing through the heat exchanger 14. However, it is also foreseeable that the dams 56 could be eliminated to result in an entirely parallel flow configuration for the heat exchanger 14, i.e., from one header 50 to the other. The interiors of the conduits 52 can be formed to have a surface texture, for example, dimples (as seen in the drawings) or other forms of turbulators, to inhibit laminar flow through the conduits 52 and thereby promote heat transfer between the conduits 52 and the fluid flowing therethrough.

In the embodiment shown in the drawings, each header 50 is provided with a fluid port 58 in fluid communication with one end of its fluid flow passage 54. The ports 58 may be provided with threads or other coupling mechanism, such as a standard fluid quick-connect coupling, to enable the port 58 to be connected to a hose (not shown) or other suitable conduit through which fluid can be supplied or drained from the unit 10. The ports 58 are oriented on the headers 50 so that their axes are parallel to and preferably in the plane of the heat exchanger 14. As evident from FIGS. 1, 2 and 3, the orientation of the ports 58 allows equal access to the ports 58 from either the front or rear side of the filter unit 10, and thereby facilitates access to the ports 58 when the unit 10 is installed in, for example, a fume hood. As also evident from FIGS. 1, 2 and 3, the lengths of the ports 58 can be sufficient so that the ports 58 protrude from the openings 74 in their respective partial enclosures 72, thereby further facilitating access to the ports 58. Preferably, as shown, the ports 58 are located on opposite ends of their respective header 50, thus contributing to the aforementioned rotational symmetry of the heat exchanger 14 and the filter unit 10 as a whole. The ends of each header 50 are shown as being closed with caps/plugs 60.

The heat exchanger 14 includes tube fins 62 on some but not all of the conduits 52. The tube fins 62 are represented in FIGS. 4, 5, 6 and 7 as plate-type through which the conduits 52 pass, though it should be understood that the tube fins 62 could be of a sinusoidal type disposed between immediately adjacent conduits 52. As seen in FIGS. 1 through 4, the tube fins 62 are installed on only those conduits 52 located within the exit openings 30 of the housing 12, and are therefore visible from the rear of the unit 10, as evident from a comparison of FIGS. 1, 2 and 3. In the front view of FIG. 2, those conduits 52 lacking the tube fins 62 (hereinafter, “upstream conduits”) are visible through the entrance openings 40 of the housing 12, but those conduits 52 equipped with tube fins 62 (hereinafter, “downstream conduits”) are concealed by the wall portions of the “upstream” wall 32 of the cover 20. In the rear view of FIG. 3, the downstream conduits 52 and their tube fins 62 are visible through the exit openings 30 in the base wall 22 of the base 18, whereas the upstream conduits 52 are concealed by the wall portions of the “downstream” wall 22 of the base 18.

In view of the foregoing, the tube fins 62 are located within downstream portions of flow paths 64 through the filter unit 10 (FIG. 4). Each flow path 64 through the unit 10 can be seen as tortuous and having an S-shape. After entering the unit 10 through one of the entrance openings 40, a majority of the incoming air initially flows around the downstream side of an upstream conduit 52 (i.e., lacking tube fins 62) and, after impinging the wall 22 of the base 18, is directed by a baffle 28 around the upstream side of a downstream conduit 52 (i.e., equipped with tube fins 62). Though not wishing to be held to any particular theories, it is believed that particulates entrained in the incoming air will largely condense on the wall 22 and baffles 28 of the base 18, as well as the baffles 38 and fin-less upstream conduits 52, all of which are located within the upstream portions of the paths 64, such that the air will not contact the downstream conduits 52 and their tube fins 62 until after at least some and preferably most of the particulates have been removed from the air. The location of the tube fins 62 also addresses the fact that, in comparison to the temperature differential that exists at the upstream conduits 52 adjacent the upstream entrance openings 40, a lower temperature differential exists between the air and the downstream conduits 52 adjacent the downstream exit openings 30.

The tube fins 62 can be installed in any suitable manner that will provide thermal contact and conduction between the tube fins 62 and the conduits 52 on which they are mounted, such that the downstream conduits 52 may have a heat transfer rate comparable to or greater than the fin-less upstream conduits 52 exposed to incoming air through the entrance openings 40. While each individual tube fin 62 is shown as comprising two openings, one for each conduit 52 passing therethrough, with each opening surrounded by a collar that promotes thermal contact with the conduits 52, it is foreseeable that each tube fin 62 could have a single “dog-bone” shaped opening that accommodates two conduits 52. In addition, though the drawings show only two conduits 52 routed through each array of tube fins 62, it is foreseeable that a single conduit 52 or more than two conduits 52 could be routed through an array of tube fins 62.

A preferred material for one or more, and preferably a majority, of the components of the heat exchanger 14 is copper, in which case a copper braze alloy can be used to join together the components of the heat exchanger 14. Exterior surfaces of the heat exchanger 14 are preferably coated with an adhesion-reducing material, a nonlimiting example can be an electrodeposited coating. The coating may be applied to those components of the heat exchanger 14 that would benefit from easier cleaning of particulates entrained in the incoming air, and particularly grease, oil and other contaminants commonly found in a kitchen environment, which are collected by the filter unit 10 during its operation. As an example, the heat exchanger 14 may be cleaned with the use of an automatic dishwasher. Other materials for the heat exchanger 14 are foreseeable and within the scope of the invention.

As evident from FIG. 4, the base 18, cover 20, walls 22 and 32, baffles 28, baffles 38, and conduits 52 all assist in creating the tortuous flow paths 64 through the cavity 16 of the filter unit 10. The entrance openings 40 formed in the base wall 32 of the cover 20 preferably perform at least a slight nozzling function on air entering the housing 12 of the unit 10. As most readily evident from FIG. 4, such an effect can be accomplished by the arrangement of pairs of baffles 38 on either side of each opening 40, in which the baffles 38 of each pair extends from their corresponding entrance opening 40 towards each other. Each baffle 38 is represented as having a substantially planar surface, such that each entrance opening 40 tapers and becomes narrower in the direction of air flow through the unit 10. The resulting nozzling effect provided by the baffles 38 focuses the incoming airflow towards the fin-less upstream conduits 52 and the wall 22 of the base 18 located directly behind the upstream conduits 52. The process of the air impacting the surfaces of the baffles 38, upstream conduits 52, and wall 22 initiates separation of entrained particulates from the incoming air. The particulates that collect on the wall 22 and baffles 28 coalesce and flow toward the flange 36 of the cover 20 located at the lower end of the housing 12, where drain holes 66 can be located. Due to the location of the drain holes 66, the unit 10 can be referred to as having a preferred orientation in which the housing 12 is oriented so that the drain holes 66 are located at a lower extremity of the unit 10.

As also evident from FIG. 4, after impacting the wall 22 of the base 18, the air flow becomes divided, with a portion 64a of the air being redirected toward one of the baffles 28 to one side of the wall 22 and the remaining portion 64b being redirected toward the baffle 28 on the other side of the wall 22. Each portion 64a and 64b is redirected by a baffle 28 towards an interior surface of the wall 32 of the cover 20, and the process of impacting the surfaces of the wall 32 causes separation of additional particulates that may have remained entrained in the air. As with the wall 22 and baffles 28, the particulates that collect on the wall 32 and baffles 38 coalesce and flow toward the drain holes 66 located at the lower end of the housing 12. Baffles 28 separated by the wall 22 of the base 18 extend from the wall 22 and toward each other, such that a pair of baffles 28 separated by one of the exit openings 30 extends towards each other. Each baffle 28 is represented as having a substantially planar surface, such that each exit opening 30 tapers and becomes wider in the direction of air flow through the unit 10, with the result that the baffles 28 can act as diffusers for air exiting the filter unit 10.

In combination, the baffles 28 and baffles 38 cause the air flowing through the housing 12 to flow around the downstream side of each upstream conduit 52, and then flow around the upstream side of each downstream conduit 52, before being allowed to exit the housing 12 through one of the exit openings 30 and 30a, effectively resulting in the S-shaped flow paths 64. Accordingly, it is preferred that no direct airflow path is provided through the filter unit 10. Rather, tortuous flow paths 64 are created thereby allowing for a turbulent flow that exposes incoming air to the heat exchanger 14 for a sufficient amount of time to allow for adequate heat exchange to a fluid flowing through the heat exchanger 14.

In view of the above, the filter unit 10 serves as both a filter and as a heat exchanger for incoming air, which if used in a kitchen environment assists in the collection of particulates and the capture of heat that would be otherwise lost. For use in a commercial kitchen, it may be preferred that multiple filter units 10 are employed, such as a series of multiple filter units 10 as represented in FIG. 9. To provide ease of connectivity, each unit 10 can be inserted into a given fume hood, ventilation unit, exhaust unit, or another type of filtration system in either of two orientations, as provided by the rotationally symmetrical of the filter units 10 evident from the drawings. For the purpose of compatibility with fume hoods, ventilation units, or exhaust units of various sizes, the unit 10 is provided with hanger clips 48 that mount to the lower end of the housing 12 and allow installation in deep hoods.

As can be seen in FIGS. 1 through 3, each pair of the partial enclosures 72 defined by the flanges 26 and 36 of the base 18 and cover 20 defines an access opening 70, one at each of the oppositely-disposed lateral ends of the filter unit 10. Regarding the particular embodiment shown in the drawings, the access openings 70 can be seen in FIGS. 2 and 3 as openings or gaps located at the lateral ends of the otherwise parallelepiped outline 76 of the filter unit 10, thereby defining a lateral narrowed section of the unit 10 that is between the access openings 70 in the lateral direction of the unit 10 and has opposite lateral ends defined by the side members 34 of the cover 20. The access openings 70 can be seen in FIGS. 1 through 3 as providing ready access to both ports 58 of the heat exchanger 14 through the openings 74 in the enclosures 72, which face each other across the access opening 70. The ends of the headers 50 of the heat exchanger 14 are exposed within the access openings 70, such that the ports 58 of the heat exchanger 14 are exposed and accessible for connecting to hoses (not shown) or other suitable conduits through which fluid can flow to and from the unit 10.

As evident from FIGS. 1 through 5, the filter unit 10 lacks handles. Instead, in addition to providing access to the ports 58 of the heat exchanger 14, the access openings 70 enable the unit 10 to be grasped during insertion and removal of the unit 10 from a fume hood, etc., or from a series of similar units 10 as represented in FIG. 9. From FIG. 9, it can be appreciated that each unit 10 can be removed from the series by grasping the narrowed section of the unit 10 between its access openings 70. When multiple units 10 are arranged end to end as shown in FIG. 9, adjacent pairs of the access openings 70 merge to define a through-passage 78 delimited by the enclosures 72 in the upper-lower directions and delimited by the narrowed sections of the adjacent units 10 in the lateral directions, and in particular the side members 34 of their respective covers 20. Incoming air would freely flow through these through-passages 78, thereby bypassing the tortuous flow paths 64 through the filter units 10. For this reason, FIG. 9 represents multiple closures 80 sized to close the passages 78 on the upstream (front) side of each unit 10. For those units 10 at each end of the series, smaller closures 82 are provided for closing their remaining access openings 70. The closures 80 and 82 are shown as being equipped with handles 84 to facilitate their removal from the access openings 70 and passages 78. In this manner, the closures 80 and 82 can be removed to allow access to the ports 58 and their hose connections while the units 10 remain installed in the series.

From the foregoing, it can be appreciated that the filter unit 10 can be employed with systems and methods to collect heat generated by a cooking surface, which would otherwise be wasted as exhaust, and transfer such heat to other locations for use in an open or closed circulation system. For example, one or more filter units 10 may be installed in an exhaust housing above a cooking surface. While the filter units 10 could be installed at any desirable angle, such as parallel to horizontal level, they are preferably installed at an angle relative to horizontal level to promote efficient drainage of collected particulates toward the drains 66, thus disposing the longitudinal dimensions of the baffles 28 and baffles 38 at approximately such angle. If multiple filter units 10 are coupled together to form an expanded filtration system, the units 10 may be coupled in series, as shown in FIG. 9, or in parallel. If coupled in series, a filter unit 10 located at one end of the series can be coupled to a fluid supply line, a filter unit 10 located at the opposite end of the series can be coupled to a storage tank, and the units 10 within the series can be connected with hoses by connecting one of its ports 58 serving as a drain port of the unit 10 to a port 58 serving as a supply port for an adjacent unit. If coupled in parallel, the supply port 58 of each unit 10 can be coupled to a fluid supply line and the drain port 58 of each unit 10 coupled to a storage tank.

While the invention has been described in terms of a specific embodiment, it is apparent that other forms could be adopted by one skilled in the art. For example, the physical configuration of a filter unit or filtration system could differ from those shown, and materials and processes other than those noted could be used. Therefore, the scope of the invention is to be limited only by the following claims.

1. A filter unit comprising:
a heat exchanger having headers and a plurality of conduits between and fluidically connecting the headers to define fluid flow passages within the heat exchanger, the headers comprising at least first and second headers that each have oppositely-disposed first and second ends, at least the first header having a port disposed at the first end thereof that is fluidically connected to the fluid flow passage within the first header; and
a housing having first and second walls and a cavity therebetween in which the heat exchanger is disposed, the first wall having at least a first entrance opening therein, the second wall having at least a first exit opening therein, the first and second walls defining a pair of partial enclosures that partially enclose the first ends of the first and second headers of the heat exchanger at a first lateral end of the filter unit, each of the partial enclosures having an opening through which a corresponding one of the first ends of the first and second headers is exposed, the partial enclosures facing each other across an access opening at the first lateral end of the filter unit, the access opening defining a lateral narrowed section of the filter unit, the access opening providing access to the first ends of the first and second headers through the openings in the partial enclosures, the access opening providing access to the port of the first header through the opening in a first of the partial enclosures.

2. A filtration system comprising first and second filter units each according to the filter unit of claim 1, wherein the port of the first filter unit is fluidically connected to the port of the second filter unit.

3. The filtration system according to claim 2, wherein the first lateral end of the first filter unit is adjacent the first lateral end of the second filter unit so that the access opening of the first filter unit and the access opening of the second filter unit define a through-passage delimited by the partial enclosures of the first filter unit, the partial enclosures of the second filter unit, and the lateral narrowed sections of the first and second filter units, and wherein the ports of the first and second filter units are disposed within the through-passage.

4. The filtration system according to claim 3, further comprising a removable closure that removably closes the through-passage at the first walls of the housings of the first and second filter units and provides access to the ports of the first and second filter units within the through-passage.

5. The filtration system according to claim 4, wherein the filtration system is installed in a kitchen environment to collect grease and oil particulates.

6. A filter unit comprising:
a heat exchanger having headers and a plurality of conduits between and fluidically connecting the headers to define fluid flow passages within the heat exchanger, the headers comprising at least first and second headers that each have oppositely-disposed first and second ends, at least the first header having a port disposed at the first end thereof that is fluidically connected to the fluid flow passage within the first header; and
a housing having an upstream wall disposed at an upstream side of the housing, a downstream wall disposed at a downstream side of the housing, and a cavity therebetween in which the heat exchanger is disposed, the upstream wall having a first entrance opening therein and first and second upstream wall portions separated by the first entrance opening, the downstream wall having first and second exit openings therein and a downstream wall portion between the first and second exit openings, the upstream and downstream walls defining first and second pairs of partial enclosures that partially enclose, respectively, the first and second ends of the first and second headers of the heat exchanger at oppositely-disposed first and second lateral ends of the filter unit, each of the partial enclosures having an opening through which a corresponding one of the first and second ends of the first and second headers is exposed, the first pair of the partial enclosures facing each other across a first access opening at the first lateral end of the filter unit, the second pair of the partial enclosures facing each other across a second access opening at the second lateral end of the filter unit, the first and second access openings defining therebetween a lateral narrowed section of the filter unit, the first and second access openings providing access to, respectively, the first and second ends of the headers through the openings in the first and second pairs of partial enclosures, the first access opening providing access to the port of the first header through the opening in a first of the partial enclosures of the first pair of partial enclosures.

7. The filter unit according to claim 6, wherein the first entrance opening is disposed in the upstream wall so as to be aligned with the downstream wall portion, and the first and second exit openings are disposed in the downstream wall so as to be aligned with, respectively, the first and second upstream wall portions.

8. The filter unit according to claim 6, wherein the conduits comprise at least first and second upstream conduits within the first entrance opening, a first downstream conduit within the first exit opening, and a second downstream conduit within the second exit opening.

9. The filter unit according to claim 8, wherein the first entrance opening, the first and second exit openings, the first and second upstream conduits, and the first and second downstream conduits are configured and arranged to define a first S-shaped air flow path through the housing between the first entrance opening and the first exit opening, and a second S-shaped air flow path through the housing between the first entrance opening and the second exit opening.

10. The filter unit according to claim 9, wherein air entering the first entrance opening flows between the first and second upstream conduits and is then separated into the first and second S-shaped air flow paths, the first S-shaped air flow path flows around a downstream side of the first upstream conduit, then around an upstream side of the first downstream conduit, then exits the housing through the first exit opening, and the second S-shaped air flow path flows around a downstream side of the second upstream conduit, then around an upstream side of the second downstream conduit, then exits the housing through the second exit opening.

11. The filter unit according to claim 10, wherein the heat exchanger comprises tube fins attached directly to the first and second downstream conduits, and the heat exchanger does not have any fins attached directly to the first and second upstream conduits.

12. A method of filtering air using the filter unit according to claim 6, the method comprising drawing air through the housing and collecting grease and oil particulates on the first and second upstream wall portions separated by the first entrance opening and on the downstream wall portion between the first and second exit openings.

13. The filter unit according to claim 6, wherein the port disposed at the first end of the first header is a supply port of the heat exchanger, the heat exchanger further comprising a drain port disposed at the second end of the second header that is fluidically connected to the fluid flow passage within the second header, the second access opening providing access to the drain port through the opening in a second of the partial enclosures of the second pair of partial enclosures.

14. A filtration system comprising first and second filter units each according to the filter unit of claim 13, wherein the drain port of the first filter unit is fluidically connected to the supply port of the second filter unit.

15. The filtration system according to claim 14, wherein the second lateral end of the first filter unit is adjacent the first lateral end of the second filter unit so that the second access opening of the first filter unit and the first access opening of the second filter unit define a through-passage delimited by the second pair of the partial enclosures of the first filter unit, the first pair of the partial enclosures of the second filter unit, and the lateral narrowed sections of the first and second filter units, and wherein the drain port of the first filter unit and the supply port of the second filter unit are disposed within the through-passage.

16. The filtration system according to claim 15, further comprising a removable closure that removably closes the through-passage on the upstream sides of the housings of the first and second filter units and provides access to the drain port of the first filter unit and the supply port of the second filter unit within the through-passage.

17. The filtration system according to claim 16, wherein the filtration system is installed in a kitchen environment to collect grease and oil particulates.

18. A method of filtering air using the filtration system according to claim 17, the method comprising drawing gasses within the kitchen environment through the housings of the first and second filter units and collecting grease and oil particulates on the upstream and downstream walls thereof.

19. A filtration system comprising:
first and second filter units arranged so that a lateral end of the first filter unit is adjacent a lateral end of the second filter unit, each of the first and second filter units having a heat exchanger within a housing that defines a flow path through the heat exchanger, the first and second filter units having lateral narrowed sections that define therebetween a through-passage through the filtration system that bypasses the flow paths of the first and second filter units, the first filter unit having a drain port and the second filter unit having a supply port that are fluidically connected to each other and are disposed within the through-passage; and
a removable closure that removably closes the through-passage and provides access to the drain port of the first filter unit and the supply port of the second filter unit within the through-passage.

20. A method of using the filtration system of claim 19, the method comprising:
removing the removable closure to expose the through-passage; and
accessing the drain port of the first filter unit and the supply port of the second filter unit through the through-passage to disconnect the drain port from the supply port.

21. A method of using the filtration system of claim 19, the method comprising:
removing the removable closure to expose the through-passage; and
grasping the lateral narrowed section of the first filter unit to remove the first filter unit from the filtration system.
